(19) United States
(12) Patent Application Publication
(10) Pub. No.: US 2012/0180441 A1
(43) Pub. Date: Jul. 19, 2012

(54) Hoof Boot

(76) Inventor: Kirt Lander, Kingman, AZ (US)

(21) Appl. No.: 13/350,674

(22) Filed: Jan. 13, 2012

Related U.S. Application Data
(60) Provisional application No. 61/432,577, filed on Jan. 13, 2011.

(51) Int. Cl. B68B 7/00

(52) U.S. Cl. 54/82

(57) ABSTRACT

A hoof boot for use on a horse that provides efficient locomotion through loose soils is disclosed. The hoof boot includes lugs of a particular shape and angle on the sole of the boot that displace the loose soil providing efficient movement for the horse through loose soils.

This application claims the benefit of U.S. provisional application No. 61/432,577 filed Jan. 13, 2011 which is incorporated herein by reference in its entirety.

### FIELD OF THE INVENTION

The present invention relates generally to a hoof boot used as a protective device on an animal, preferably a horse. The hoof boot of the present invention has a unique sole with lugs that allows the animal to easily move through loose soils such as sand and mud.

### BACKGROUND OF THE INVENTION

The horse, being domesticated for six to seven thousand years, often needs supplemental hoof protection due to reduced hoof conditioning as a result of confinement. While in the past one to two thousand years, the nail on metal horse shoe has become the dominant method of said hoof protection, an alternative method of hoof protection known as the strap-on hoof boot actually predates the metal horse shoe by many thousands of years and possibly dates very near the earliest time of equine domestication, for the moment the horse is taken from the wild, its hooves begin to lose their conditioning, reducing their level of performance, prompting man to implement various forms of supplemental hoof protection.

In the past, materials technology was not what it is today, limiting the performance potential of the strap-on type hoof protection. When the Iron Age came into being, the nail-on metal horse shoe was developed as a more durable means of protection of the hoof and has been the dominant form of hoof protection for the past one to two thousand years. In more recent times, strap-on and glue-on type hoof boots comprised of modern elastomeric materials have come into existence which exhibit the necessary durability to withstand hard use upon the hooves of the horse and which also enhance the performance of the horse and further protect the hoof from shock and concussion as compared to a metal shoe. These types of hoof boots generally cover the entire solar surface of the hoof and incorporate some form of tread design for the purpose of engaging the surface ridden upon.

Considering the various hoof boot tread designs on the market and those as found in various patents and patent applications, none of these designs are maximized for performance in loose soil conditions such as sand and mud. Some of the patent and patent applications in the prior art are U.S. Pat. No. 3,732,929 issued to Glass, U.S. Pat. No. 3,703,209 issued to Glass, U.S. Pat. No. 1,710,909 issued to Watson, U.S. Pat. No. D616,614 issued to Ruetenik, U.S. Pat. No. D612,550 issued to Justis, U.S. Pat. No. D572,867 issued to Justis, U.S. Pat. No. D565,256 issued to Ruetenik, U.S. Pat. No. D026,835 issued to Hirsch, U.S. Pat. No. 7,207,163 issued to Maestrini, U.S. Pat. No. 5,224,549 issued to Lightner, U.S. Pat. No. 4,899,824 issued to Techer et al., U.S. Pat. No. 4,736,800 issued to Rohner, U.S. Pat. No. 4,189,004 issued to Glass, U.S. Pat. No. 3,794,119 issued to Paiso et al., U.S. Pub. No. 20110067366 invented by Ruetenik, U.S. Pub. No. 20090235621 invented by Ford, U.S. Pub. No. 20070033909 invented by Lustgarten, UK Pat No. 2,338,394 to Iles, FR Pat. No. 1,330,249 to Rebeillard, DE U.S. Pat. No. 3,311,383 to Zenhausern et al., and DE U.S. Pat. No. 2,316,573 to Hufkissenbeschlag all of which are incorporated herein by reference. As is generally obvious to the layman, sand and mud present a difficult challenge to locomotion whether it is a human or a horse moving upon the soil.

Furthermore, traditional metal horse shoes being U shaped and not normally fully covering the ground contact surface of the hoof, are inherently disadvantaged and restricted. More modern fully elastomeric hoof boot designs such as those mentioned above do, however, offer an improved foundation for various tread designs which enhance traction and forward locomotion of the horse in loose sandy soil conditions above and beyond what is possible with traditional U shaped metal horse shoes.

The present invention includes a new and improved apparatus for horse hoof protection and traction. The improvement includes a hoof boot that allows for increased soil traction and enhanced movement and locomotion on loose soils (i.e. sand). Over a long distance, a mere 1-2% enhancement of the locomotive efficiency of a horse makes a large impact on the finishing position and energy level of the horse. The horses using the present invention benefit from improved traction, locomotion and decreased shock and concussion compared to conventional metal racing plates.

### SUMMARY OF THE INVENTION

The present invention is directed to a hoof boot with a fully covered sole and lugs that enhance traction in loose soil conditions.

The hoof boot of the present invention comprises a sole including a bottom, a toe region, a heel region, a first side, a second side, and at least two lugs. The two lugs are coupled to the bottom of the sole of the hoof boot and extend across the sole of the hoof boot from the first side to the second side. The lugs are arranged along the sole of the hoof boot from the heel region to the toe region. The lug at the heel region of the boot is thick and partially slides. The lugs displace soil and provide efficient locomotion and traction of the hoof in the soil.

It is an object of the present invention to provide a hoof boot that increases an animal's traction in loose soils.

It is a further object of the present invention to provide a hoof boot that straps on to an animal's hoof.

It is a further object of the present invention to provide a hoof boot that may be attached to an animals hoof with adhesive.

It is a further object of the present invention to provide a hoof boot that is made of an elastomeric polymer material.

It is a further object of the present invention to provide a hoof boot that is cost effective to manufacture.

The novel features that are considered characteristic of the invention are set forth with particularity in the appended claims. The invention itself, however, both as to its structure and its operation together with the additional object and advantages thereof will best be understood from the following description of the preferred embodiment of the hoof boot. Unless specifically noted, it is intended that the words and phrases in the specification and claims be given the ordinary and accustomed meaning to those of ordinary skill in the applicable art or arts. If any other meaning is intended, the specification will specifically state that a special meaning is being applied to a word or phrase Likewise, the use of the words “function” or “means” in the Description of Preferred Embodiments is not intended to indicate a desire to invoke the special provision of 35 U.S.C. §112, paragraph 6 to define the invention. To the contrary, if the provisions of 35 U.S.C. §112, paragraph 6 are sought to be invoked to define the invention(s), the claims will specifically state the phrases “means for” or “step for” and a function, without also reciting in such phrases any structure, material, or act in support of the function.

Moreover, even if the provisions of 35 U.S.C. §112, paragraph 6 are invoked to define the inventions, it is intended that the inventions not be limited only to the specific structure, material or acts that are described in the preferred embodiments, but in addition, include any and all structures, materials or acts that perform the claimed function, along with any and all known or later developed equivalent structures, materials, or acts for performing the claimed function.

### BRIEF DESCRIPTION OF THE DRAWINGS

FIG. 1 shows a bottom view of the hoof boot.

FIG. 2 shows a mid-line cross section view of the hoof boot.

FIG. 3 shows a first side view of the hoof boot.

FIG. 4 shows a second side view of the hoof boot.

FIG. 5 shows a rear perspective view of the hoof boot.

FIG. 6 shows a cross section of the preferred embodiment of the hoof boot engaging the loose soil as the horse hoof moves in a rocker motion from heel to toe.

FIG. 7 shows a cross section of the preferred embodiment of the hoof boot engaging the loose soil as the horse hoof moves in a rocker motion from heel to toe.

FIG. 8 shows a cross section of the preferred embodiment of the hoof boot engaging the loose soil as the horse hoof moves in a rocker motion from heel to toe.

FIG. 9 shows a cross section of the preferred embodiment of the hoof boot engaging the loose soil as the horse hoof moves in a rocker motion from heel to toe.

FIG. 10 shows a cross section of the preferred embodiment of the hoof boot engaging the loose soil as the horse hoof moves in a rocker motion from heel to toe.

FIG. 11 shows a cross section of the preferred embodiment of the hoof boot engaging the loose soil as the horse hoof moves in a rocker motion from heel to toe.

FIG. 12 shows a cross section of the preferred embodiment of the hoof boot engaging the loose soil as the horse hoof moves in a rocker motion from heel to toe.

FIG. 13 shows a cross section of the preferred embodiment of the hoof boot engaging the loose soil as the horse hoof moves in a rocker motion from heel to toe.

FIG. 14 shows a cross section of the preferred embodiment of the hoof boot engaging the loose soil as the horse hoof moves in a rocker motion from heel to toe.

FIG. 15 shows a cross section of the preferred embodiment of the hoof boot engaging the loose soil as the horse hoof moves in a rocker motion from heel to toe.

FIG. 16 shows a cross section of the preferred embodiment of the hoof boot engaging the loose soil as the horse hoof moves in a rocker motion from heel to toe.

FIG. 17 shows a cross section of the preferred embodiment of the hoof boot engaging the loose soil as the horse hoof moves in a rocker motion from heel to toe.

### DESCRIPTION OF PREFERRED EMBODIMENTS

The present invention relates to a horse hoof boot 5 for protecting the hooves of a horse and improving traction and locomotion in loose soils. More specifically, the hoof boot 5 includes lugs 10 on the sole 20 of the hoot boot 5 that increase the soil traction of the horse hoof, thereby enhancing movement and locomotion on loose soils.

In the preferred embodiment, the hoof boot 5 includes a sole 20 that covers the entire sole surface of the horse hoof. The hoof boot 5 can be secured to the horse hoof either by gluing the boot 5 to the hoof or by utilizing a strap on design. It is preferred that the hoof boot 5 is made of an elastomeric material to enhance the performance of the boot 5 and reduce shock and concussion to the hoof capsule of the horse. In both the strap on and glue on hoof boot 5 designs, the sole 20 of the hoof boot 5 is integral with the boot 5. This integral design provides enhanced structural integrity to the boot 5, thereby providing enhanced traction in loose soil conditions.

In the preferred embodiment, the bottom 25 of the sole 20 of the boot 5 comprises lugs 10 that grip into the soil. For the present invention, a lug 10 is defined as a ridge or welt that helps to provide traction as on the sole of a shoe. The lugs 10 aid in the performance of a horse over loose soil by allowing the boot 5 to engage, drag, and carry portions of the loose soil as the horse moves over the soil.

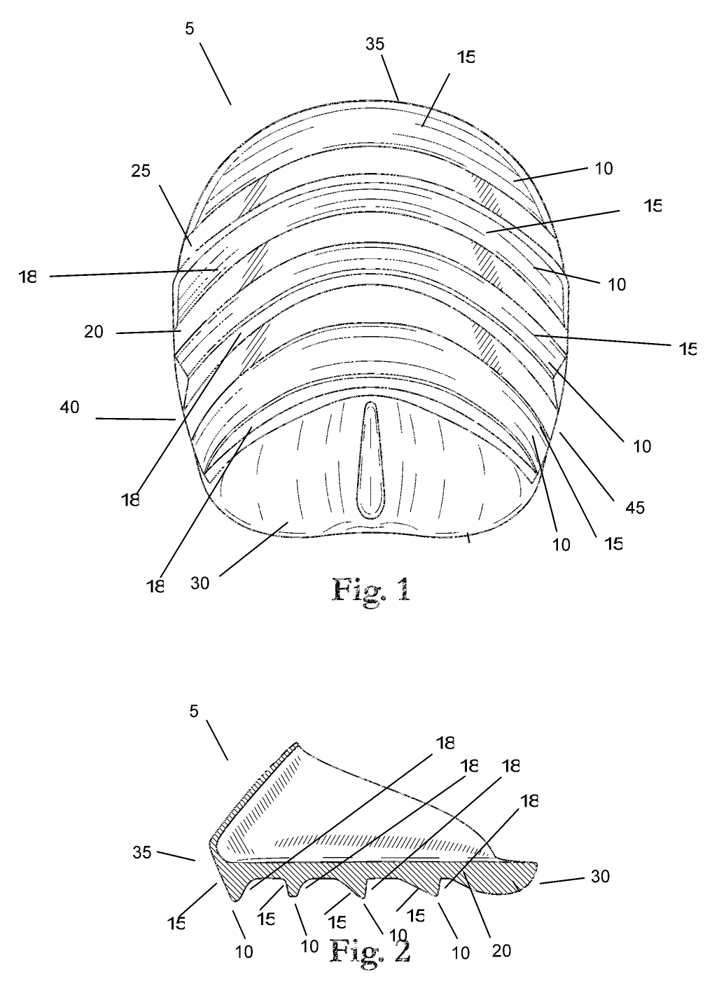

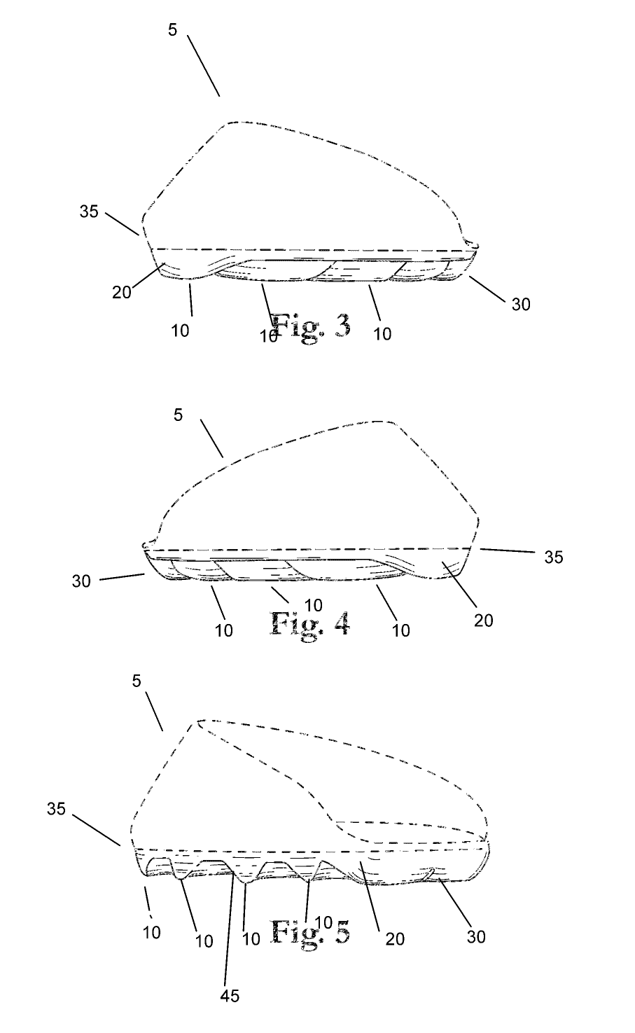

As seen in FIG. 1, in the preferred embodiment of the invention, there are at least four (4) lugs 10 spaced along the sole 20 of the boot 5 from the heel region 30 of the boot 5 to the toe region 35 of the boot 5. These lugs 10 are arranged such that they extend from a first side 40 of the hoof boot 5 across the sole to a second side 45 of the hoof boot 5 as shown in FIG. 1.

The lugs 10 can be of differing shapes and sizes and may incorporate various channels or notches. The channels and notches of the hoot boot 5 vary depending on the soil conditions upon which the horse is travelling. The lugs 10 may also be of block shapes, scoop shapes, or curved and scoop shaped ridges and pockets. In addition, the lugs 10 may be of curved, circular, semicircular, V, square, rectangular or straight configurations or a combination thereof.

Very deep and dry sand and very deep and fine grained mud are the most difficult soil conditions for which a horse to tread. In this case, it is preferred that the lugs 10 of the hoof boot 5 are as tall as practical and the cross sectional shape should be that of a rearward curved scoop with a thin edge that allows the tall lug to easily penetrate the sand to full depth of the lug 10. This affords maximum engagement of the lug 10 and hoof boot 5 with the sand. It is also preferred that the lugs 10 are as thin as practical while still retaining enough resistance to deformation when the hoof boot 5 applies force to the soil. If the sand or mud contains gravel and rocks, the lugs 10 described above would be too delicate necessitating a thicker profile and edge to better resist wear from the gravel and rocks.

In another embodiment, when the soil is a thin layer of sand or mud upon a firm base, the lugs 10 may be shaped with more of a rectangular cross section with the intent of projecting through said layer so as to allow the lug 10 to engage the firm surface underneath. Said lugs 10 may be notched so as to increase contact pressure with the underlying firm base. Furthermore, the linear shape of said lugs 10 may be of a rearward pointed V-shape. This shape promotes the clearing or wiping away of the surface so as to remove and laterally eject the loose part of the surface thereby better exposing the firm soil layer underneath for better engagement by the flat part of the lug face.

Moreover, the orientation and linear shape of the various lugs 10 may be optimized depending upon the intent of the rider of the horse. For example, an endurance horse will mostly be traveling in a relatively straight line pathway with mostly gradual turns. This type of horse will travel at medium speeds mostly in the trot or slow canter. In this situation, it is preferred that the linear shape of the lugs 10 should be symmetrical from side to side with an arc form wherein the peak of the arc is toward the front of the boot and at its mid line. The curved shape helps to form a rearward facing pocket that enhances the entrapment of the soil. This in turn helps to keep the soil from slipping past the lateral edges of the lugs 10. Thus, the quantity of soil available to impart inertial resistance is maximized.

In yet another embodiment of the invention, the horses may be engaged in the sport of flat track racing. Flat track racing is usually done on an oval shaped track of ¾ mile or more. In such competitions, the horses are traveling at great speed. As such, the horses will be encountering the turns at each end of the oval at a fast pace. As the physics of traversing a turn require lateral acceleration, the lugs 10 may be shaped differently so as to facilitate lateral traction. For example, the linear path of the lugs would begin at a first side 40 of the boot 5 and curve forward as it approaches the mid line and then curve rearward as it approaches the second side 45. This would be in a non-symmetrical manner where one side of the lug 10 would terminate at the first side 40 more forward from the second side 45. Essentially, the non-symmetrical curve shape would present a pocket facing the rear but canted toward the outside of the turn. Thus, enhancing lateral thrust needed for lateral acceleration. The orientation of the lugs 10 can be varied to find a balance between forward thrust and lateral thrust.

The angles and shapes of the lugs 10 on the bottom 25 of the sole 20 of the hoof boot 5 preferably change depending on their position relative to the heel, toe, and periphery of the hoof. This design element is important because when moving, a horse's heel is typically the first part of the hoof to contact the ground followed by the toe in a rocking type motion. As such, in the presently preferred design, the rear portion of the hoof boot 5 is preferably the first surface to hit the ground and engage the soil. The rear portion of the hoof boot 5 is thick and shaped to partially slide in order to absorb the initial shock of the hoof contact.

In the preferred embodiment, there are four (4) lugs 10 on the hoof boot 5, as seen in FIG. 1. The four lugs 10 include a front face 15 and a rear face 18. As the lugs 10 progress from the heel region 30 of the hoof boot 5 to the toe region 35 of the hoof boot 5, the angles of the front faces 15 of the first three lugs 10 progressively become steeper in relation to the sole 20 of the hoof boot 5. The front face 15 of the lug 10 closest to the toe region 35, however, angles back toward the sole 20 of the hoof boot 5.

In an alternate embodiment not shown, the hoof boot 5 has an enlarged heel pad. In this instance, the hoof boot 5 includes three (3) lugs 10 as opposed to four (4) lugs 10. The lugs 10 and hoof boot 5 functions in a similar way as with the four (4) lugs 10, but only includes three (3).

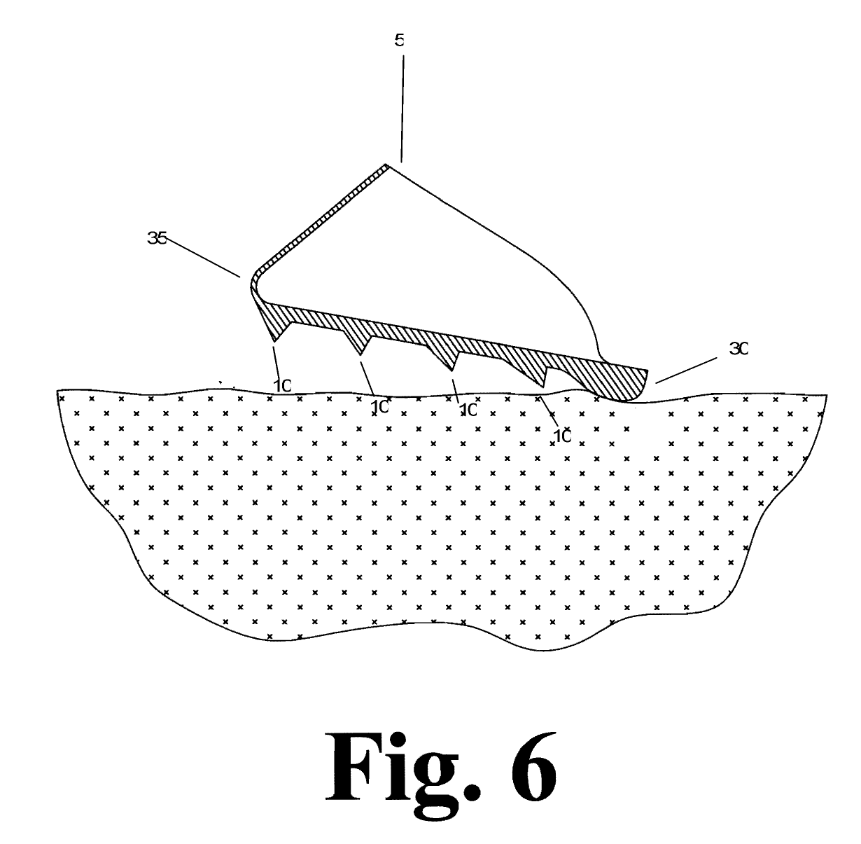

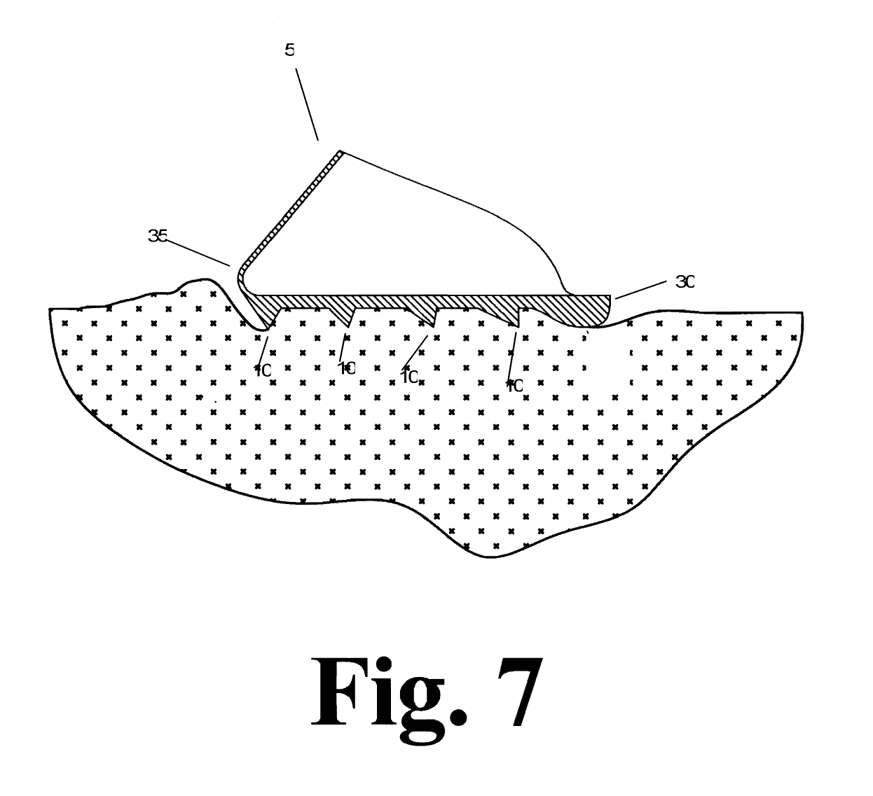

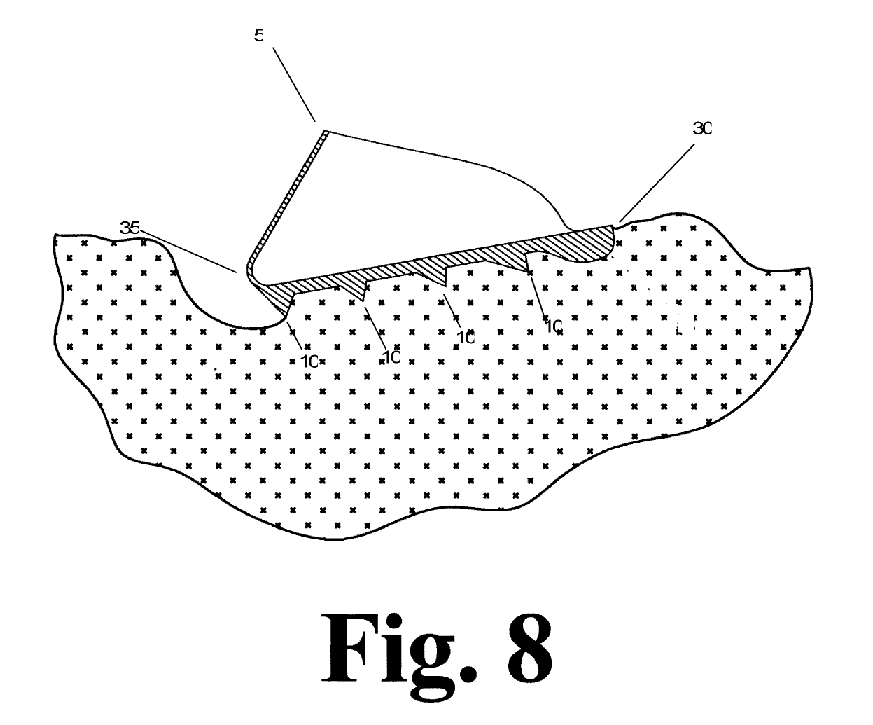

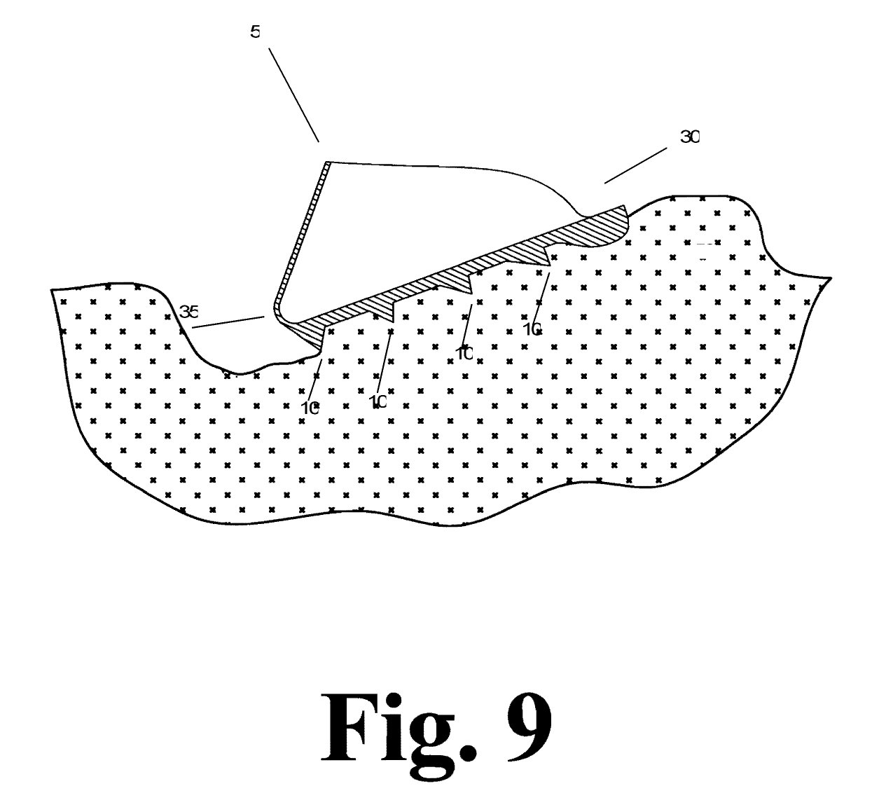

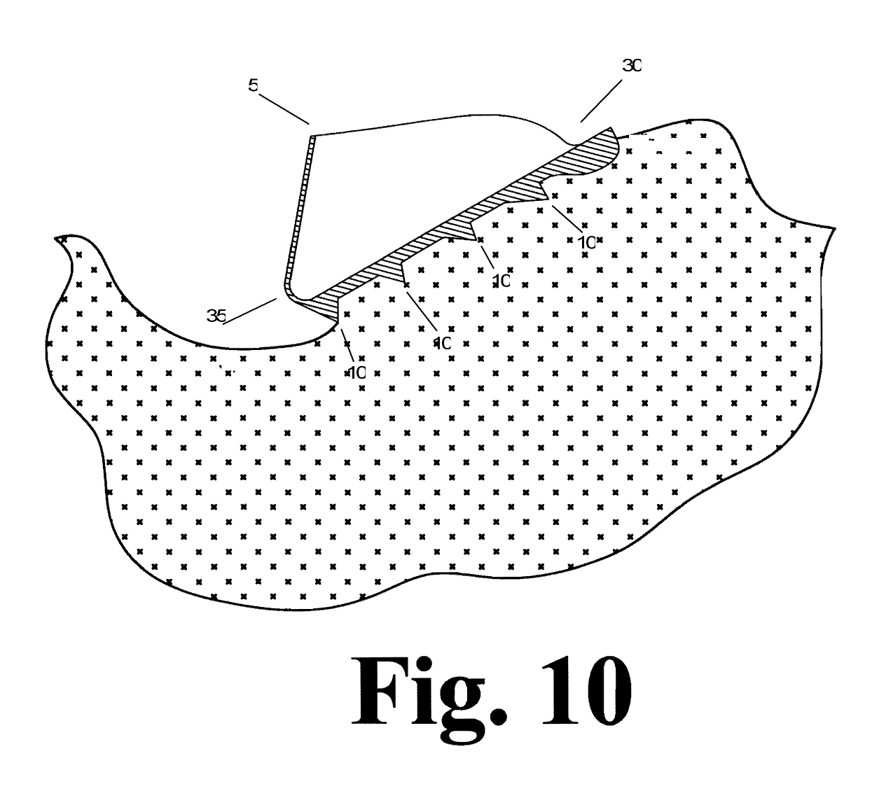

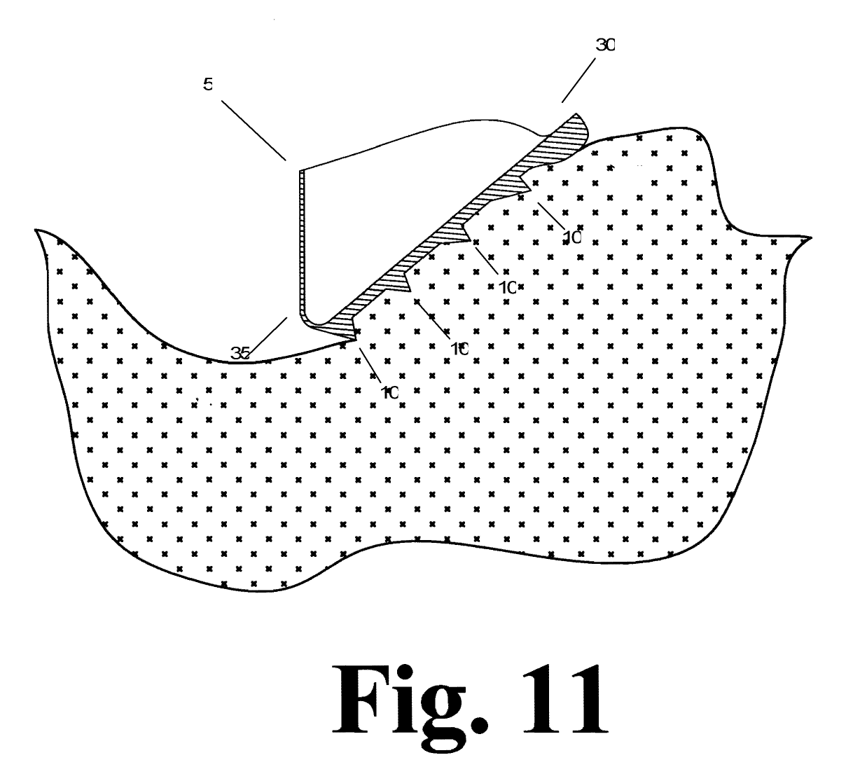

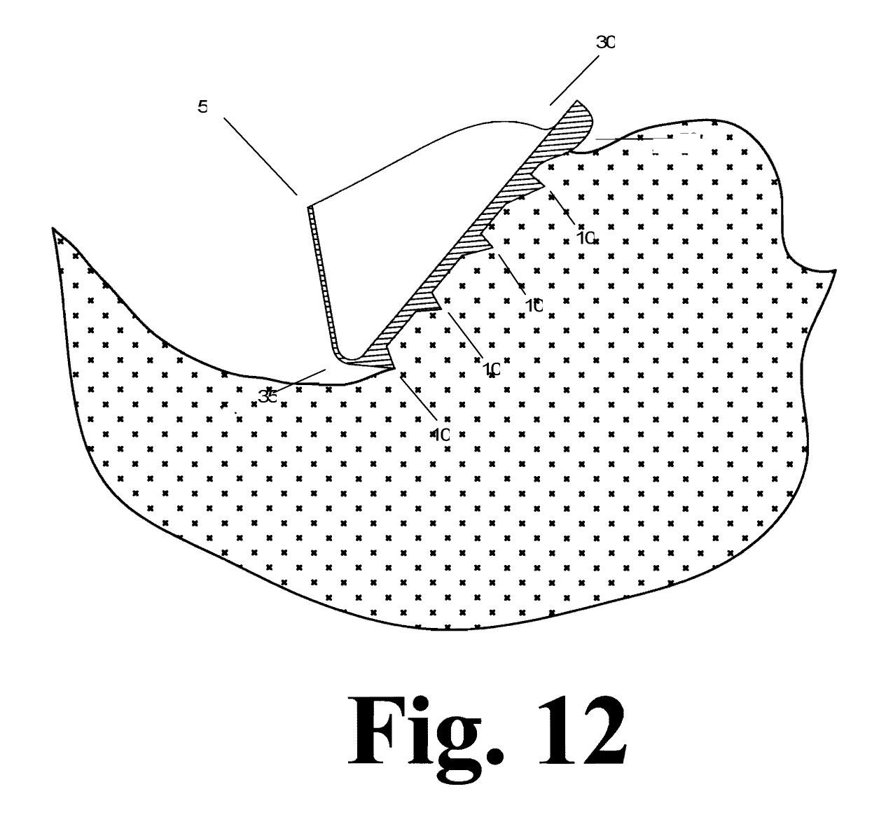

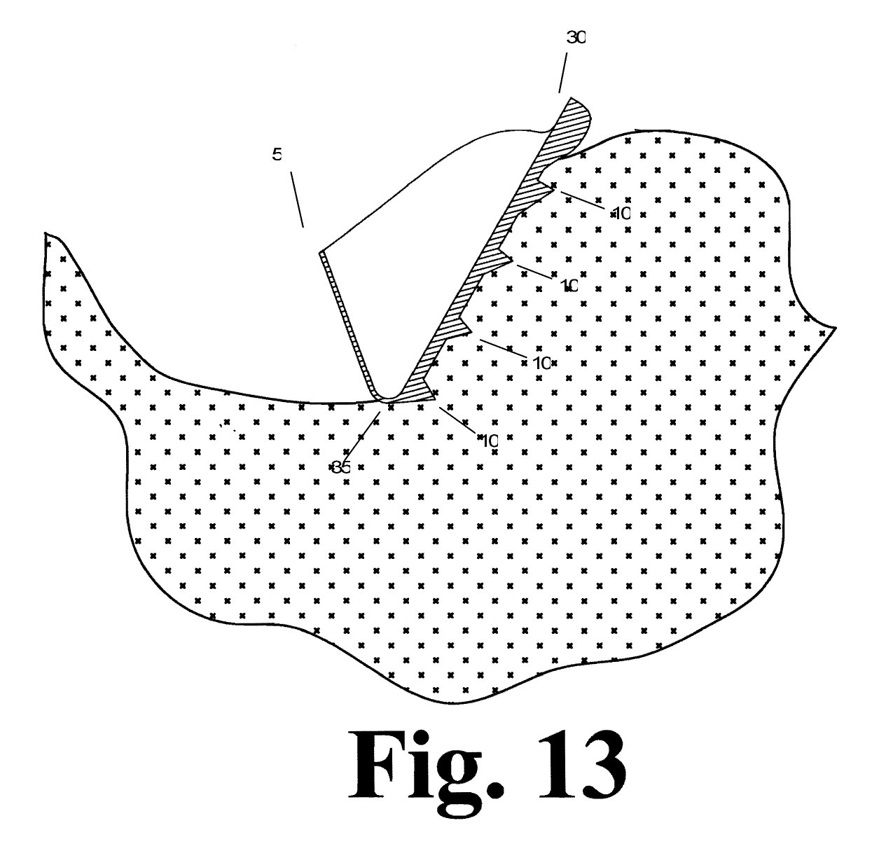

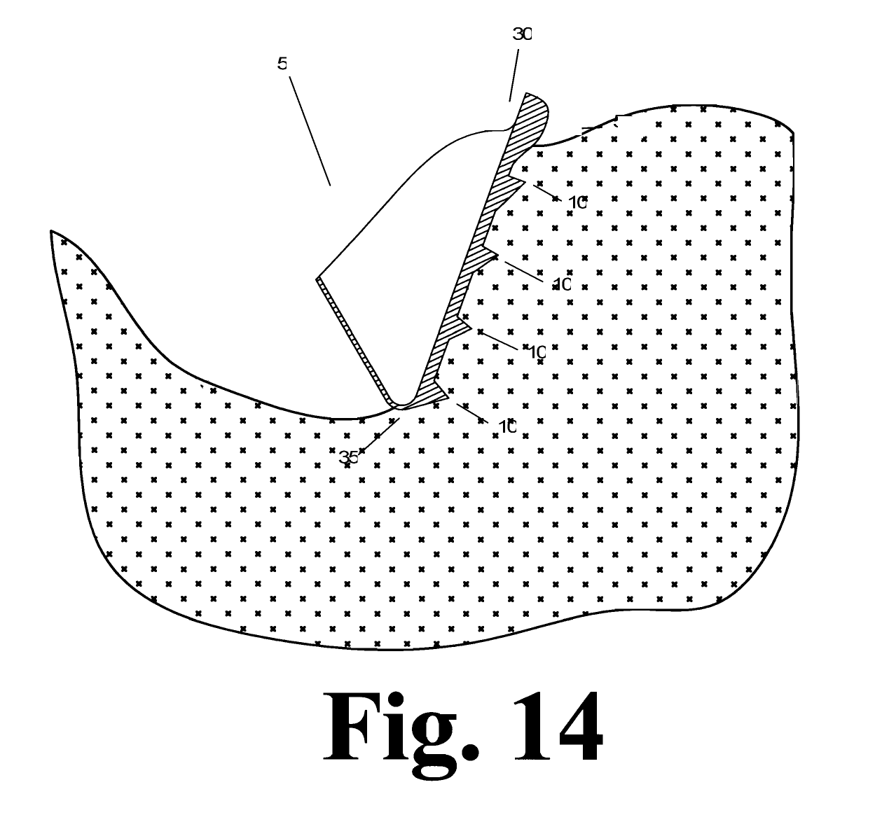

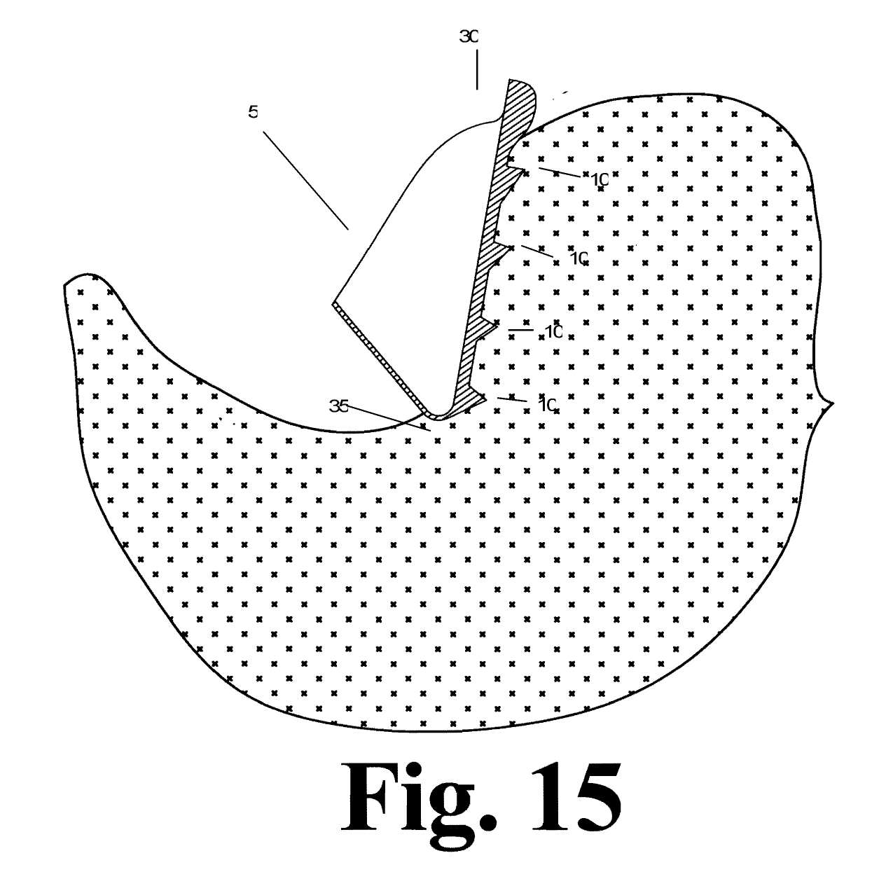

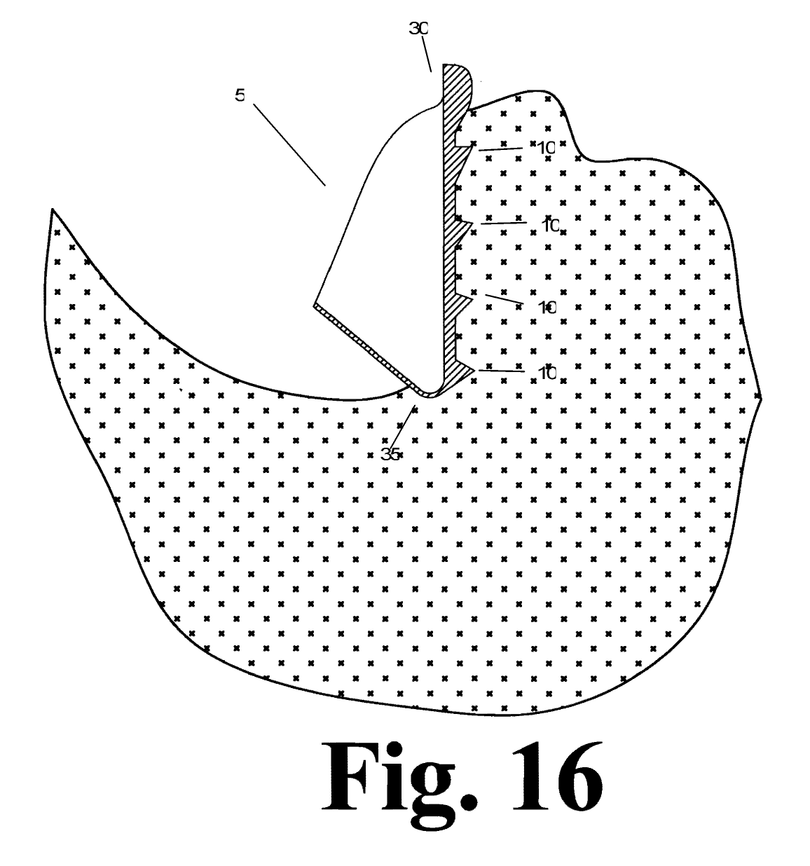

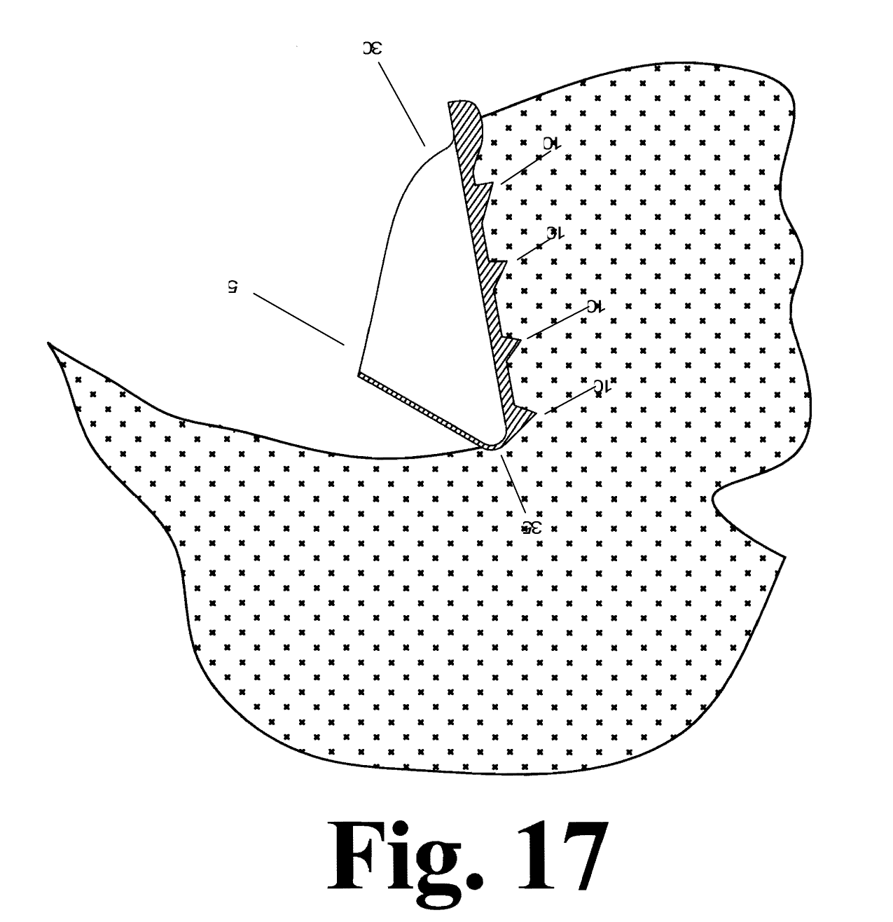

As the bio mechanics of the horse are such that the hoof lands heel first during gait, the rearmost lug 10 of the hoof boot 5 should be shaped to afford a slight slipping of or sliding of the boot 5 upon initial contact with the ground. That is, the heel of the boot 5 should be shaped with a tapered, sloped or ramped leading edge similar to the mid line profile of a water craft, water ski, or snow ski. This allows the heel to slidingly float on the sand providing less initial resistance upon first contact. The result is less abrupt column loading of the equine leg, thereby reducing stress upon the joints. The rearmost lug 10 in the drawings depicts this shape. FIGS. 6-17 show the motion of the horse hoof and hoof boot as it is moving in the rocker motion through the soil.

It is preferred that each lug 10 in sequential order moving from the heel toward the toe is angled and shaped to displace and engage the soil in an optimal manner as the horse's hoof weight bearing moves from heel to toe in a rocker motion. As the horse begins to apply rearward force with the legs and as the loading of the hoof moves from heel to toe, so too does the area of the hoof most in contact with the ground engage the soil. Therefore, the previously mentioned change in shape and angle of the various lugs 10 advantageously and optimally engage the soil.

Additionally, as the heel of the horse contacts the ground first followed by the toe and continuing in a rocking motion as the hoof transitions from initial weight bearing into applying rearward force, the toe sinks deeper into the ground in a heel to toe rocker motion. The angular relationship of the sole of the hoof boot changes relative to the ground and to the force being applied to the ground. Therefore, the cross sectional shape of various sequential lugs 10 should vary too with those lugs 10 toward the heel being angled more rearward and those lugs 10 the toe being angled more vertical.

As the toe region 35 of the hoof and boot 5 bear down upon the soil, the toe generally also angles downward and the force at the toe causes the hoof and boot 5 to sink downward into the soil. The lug 10 of the boot 5 at the toe is likewise advantageously angled and shaped to maximize engagement with the soil in the toe region 35 of the boot 5. As the horse applies force to the soil, the boot's 5 angular relationship to the toe ground plane also changes from one of positive angle at the toe upon first weight bearing to positive angle at the heel upon last contact with the ground in a constantly changing rocker motion hence the advantages brought forward in providing multiple lugs 10 of varying shapes, angles, and sizes. Said shapes, angles and sizes correlating with the various ground plane angles encountered during first contact and full engagement of the hoof boot 5 with the ground until final departure and gait flight. In this manner, the hoof boot 5 of the invention offers far superior capabilities of traction as is possible with conventional metal shoes and their various accessory features.

The preferred embodiment of the invention is described in the Description of Preferred Embodiments. While these descriptions directly describe the one embodiment, it is understood that those skilled in the art may conceive modifications and/or variations to the specific embodiments shown and described herein. Any such modifications or variations that fall within the purview of this description are intended to be included therein as well. Unless specifically noted, it is the intention of the inventor that the words and phrases in the specification and claims be given the ordinary and accustomed meanings to those of ordinary skill in the applicable art(s). The foregoing description of a preferred embodiment and best mode of the invention known to the applicant at the time of filing the application has been presented and is intended for the purposes of illustration and description. It is not intended to be exhaustive or to limit the invention to the precise form disclosed, and many modifications and variations are possible in the light of the above teachings. The embodiment was chosen and described in order to best explain the principles of the invention and its practical application and to enable others skilled in the art to best utilize the invention in various embodiments and with various modifications as are suited to the particular use contemplated.

What is claimed is:

1. A hoof boot for use on a hoof comprising:
a. a sole including a bottom wherein the sole fully covers the bottom of the hoof;
b. a toe region;
c. a heel region;
d. a first side;
e. a second side; and
f. at least two lugs wherein the lugs are coupled to the bottom of the sole of the hoof boot and extend across the sole of the hoof boot from the first side to the second side;
g. wherein the lugs are arranged along the sole of the hoof boot from the heel region to the toe region;
h. wherein the lug at the heel region of the hoof boot is thick and partially slides; and
i. wherein the lugs displace soil and provide efficient locomotion and traction of the hoof in the soil.

2. The hoof boot of claim 1 wherein the lugs further comprise a rearward curved scoop cross sectional shape and a thin edge such that the lugs penetrate the soil to a full depth of the lug.

3. The hoof boot of claim 1 wherein the lugs at the heel region of the hoof boot are angled rearward relative to the sole of the hoof boot.

4. The hoof boot of claim 1 wherein the lugs at the toe region of the hoof boot are angled vertical relative to the sole of the hoof boot.

5. The hoof boot of claim 1 wherein the lugs are arranged symmetrically along the sole of the hoof boot from the heel region to the toe region.

6. The hoof boot of claim 1 wherein the hoof boot comprises an elastomeric material.

7. The hoof boot of claim 1 wherein the hoof boot comprises four lugs.

8. A hoof boot for use on a hoof comprising:
a. a sole including a bottom wherein the sole fully covers the bottom of the hoof;
b. a toe region;
c. a heel region;
d. a first side;
e. a second side; and
f. at least two lugs wherein the lugs are coupled to the bottom of the sole of the hoof boot and extend across the sole of the hoof boot from the first side to the second side;
g. wherein the lugs are arranged along the sole of the hoof boot from the heel region to the toe region;
h. wherein the lug at the heel portion of the hoof boot is thick and partially slides; and
i. wherein the lugs displace soil and provide efficient locomotion and traction of the hoof in the soil.

9. The hoof boot of claim 9 wherein the lugs are arranged symmetrically along the sole of the hoof boot from the heel region to the toe region.

10. The hoof boot of claim 9 wherein the lugs are arranged non-symmetrically along the sole of the hoof boot from the heel region to the toe region.

11. The hoof boot of claim 9 wherein the hoof boot comprises an elastomeric material.

12. The hoof boot of claim 9 wherein the lugs are selected from the group consisting of:
a. blocks;
b. scoops;
c. ridges;
d. pockets; and
e. combinations thereof.

13. The hoof boot of claim 13 wherein the shape of the lugs are selected from the group consisting of:
a. curved;
b. circular;
c. semicircular;
d. V-shaped;
e. square;
f. rectangular;
g. straight; and
h. combinations thereof.
